(19) United States
(12) Patent Application Publication
(10) Pub. No.: US 2015/0274085 A1
(43) Pub. Date: Oct. 1, 2015

(54) Trash bin caddie

(71) Applicant: Mark Underhill Martin, Harrisburg, NC (US)

(72) Inventor: Mark Underhill Martin, Harrisburg, NC (US)

(21) Appl. No.: 14/227,520

(22) Filed: Mar. 27, 2014

(51) Int. Cl. B60R 9/06; B60R 11/00

(52) U.S. Cl. CPC B60R 9/06; B60R 11/00; B60R 2011/005

(57) ABSTRACT

The harness concept and design utilized by Trash bin caddie is a first of a kind for the waste management industry regarding towing rolling trash bins and recyclable containers with an automotive vehicle. Other attempts and products targeted at towing rolling trash bins and recyclable containers have focused on leveraging a towing hitch mounted on the automotive vehicle. Most people do not purchase automotive vehicles with towing packages added nor do they have a need to add such towing packages later on. Adding a towing hitch adds to the cost of the automotive vehicle and would add to the cost of using the other products attempting to aid people in the transport of their rolling trash bin and recyclable containers. Trash bin caddie does not require a towing hitch mounted to the vehicle. Trash bin caddie is strong, lightweight and easily stores inside the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Trash Bin Caddie is designed to aid people in the transport of their rolling curbside trash bin and/or recyclable containers to and/or from their home and/or place of dwelling. Waste Management companies are expanding their areas of service into the suburbs and rural areas of municipalities all over the United States. Many of these new customers live on larger parcels of land with their home and/or dwelling located at a greater distance from the designated curbside pick-up specified by their waste management provider. Often their driveways consist of a variety of coverage material (paved, gravel, dirt, etc. . . . ) and may also include various elevation levels in the topography. This combination of lengthy driveways and various terrains creates a challenging task, on a regular schedule, for people to meet the requirements of disposing of their waste.

### BRIEF SUMMARY OF THE INVENTION

Trash Bin Caddie is a ‘harness’ type device made from nylon webbing. Other items involved in the construction of Trash Bin Caddie include a wood dowel and velcro straps; all items are readily available commercially. Trash Bin Caddie easily mounts to automobiles of a wide variety. Cars, trucks, and SUVs can all use Trash Bin Caddie. No additional automotive products and/or accessories are required to use Trash Bin Caddie. Trash Bin Caddie is 14″ wide to accommodate variations in rolling trash bin measurements. The velcro straps allow for adjustments to meet individual needs. The design of Trash Bin Caddie allows for people to easily tow their rolling trash bin and/or recyclable containers behind their vehicles, safely and securely. While the greater benefit of Trash Bin Caddie is targeted towards people with driveways of greater distances, people who have shorter driveways (perhaps less than 100 feet), can also benefit from the use of Trash Bin Caddie. It saves them the effort of making an extra trip to the curbside on waste collection day, especially if they have any physical circumstances which would make the transport of their rolling trash bin and/or recyclable container difficult.

### BRIEF DESCRIPTION OF THE SEVERAL VIEWS OF THE DRAWING

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example of the finished product (Trash Bin Caddie), also includes the overall dimensions of the finished product as well as the location and pattern of the stitching required in the assembly process.

FIG. 2 illustrates the various components used in the assembly process of the finished product (Trash Bin Caddie), includes references to illustrations of each individual component.

FIG. 2A illustrates the 14″ Nylon Webbing component used in the assembly process of the finished product (Trash Bin Caddie).

FIG. 2B illustrates the ½″ Wood Dowl component used in the assembly process of the finished product (Trash Bin Caddie).

FIG. 2C illustrates the 6″ Nylon Webbing component used in the assembly process of the finished product (Trash Bin Caddie).

FIG. 2D illustrates the Velcro Strap component used in the assembly process of the finished product (Trash Bin Caddie).

### DETAILED DESCRIPTION OF THE INVENTION

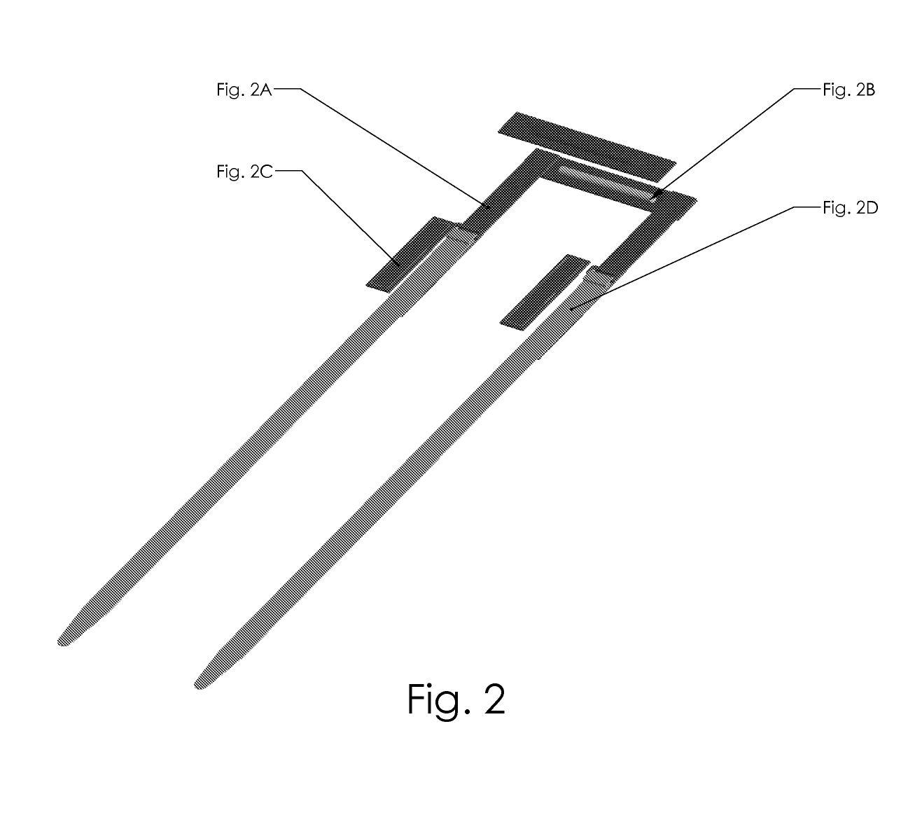

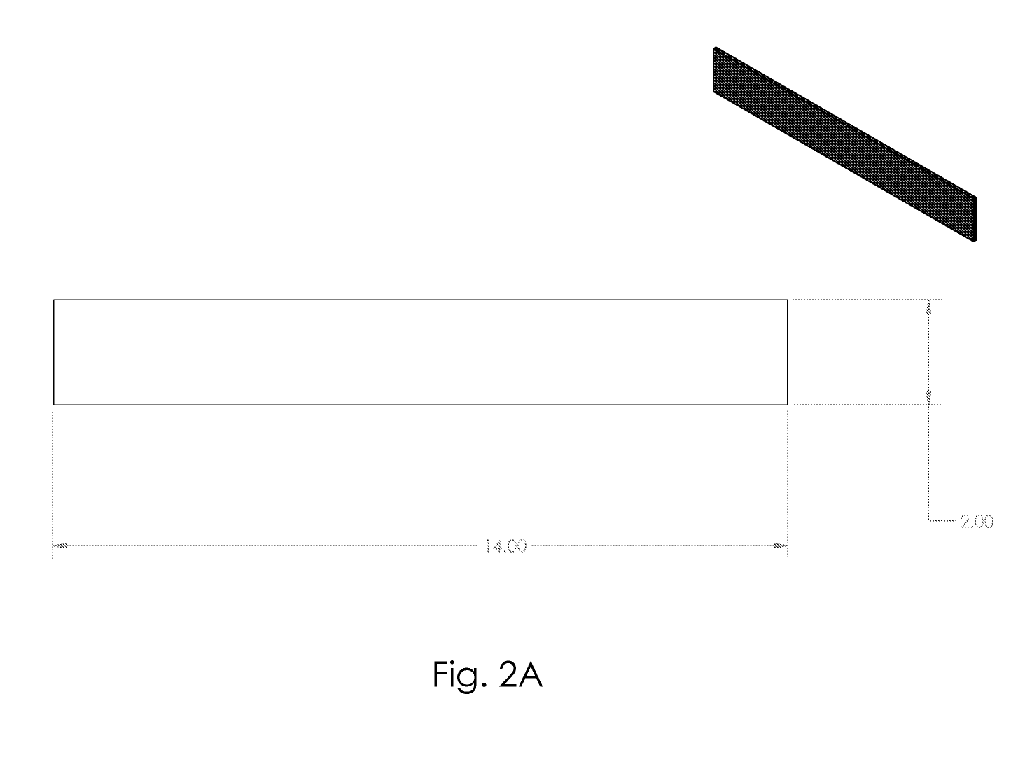

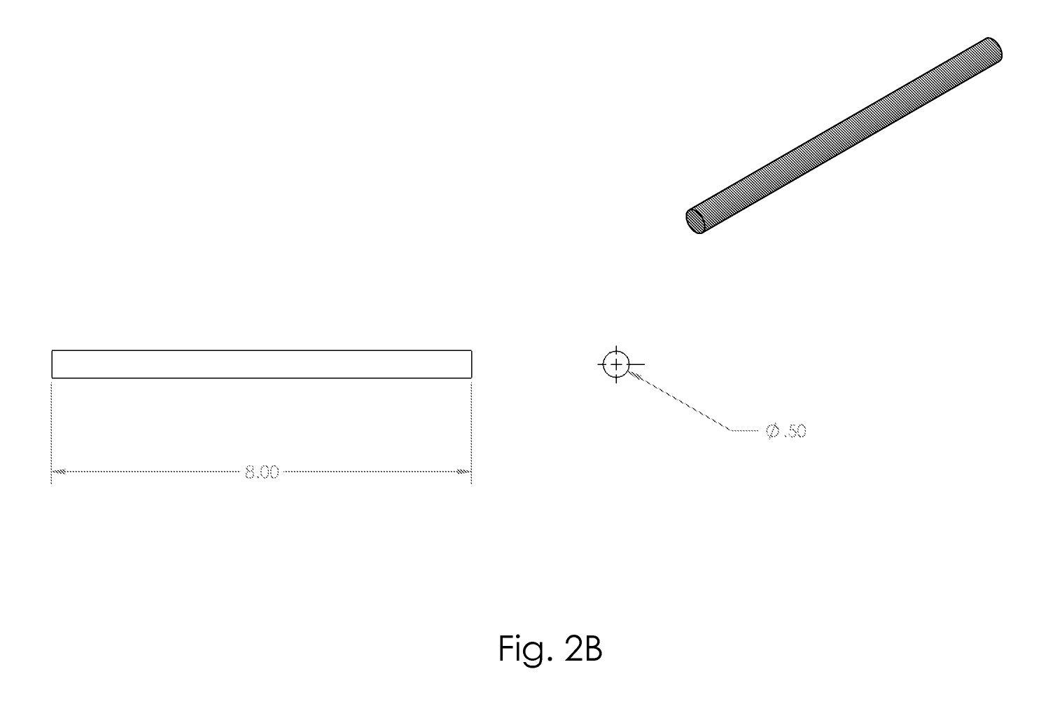

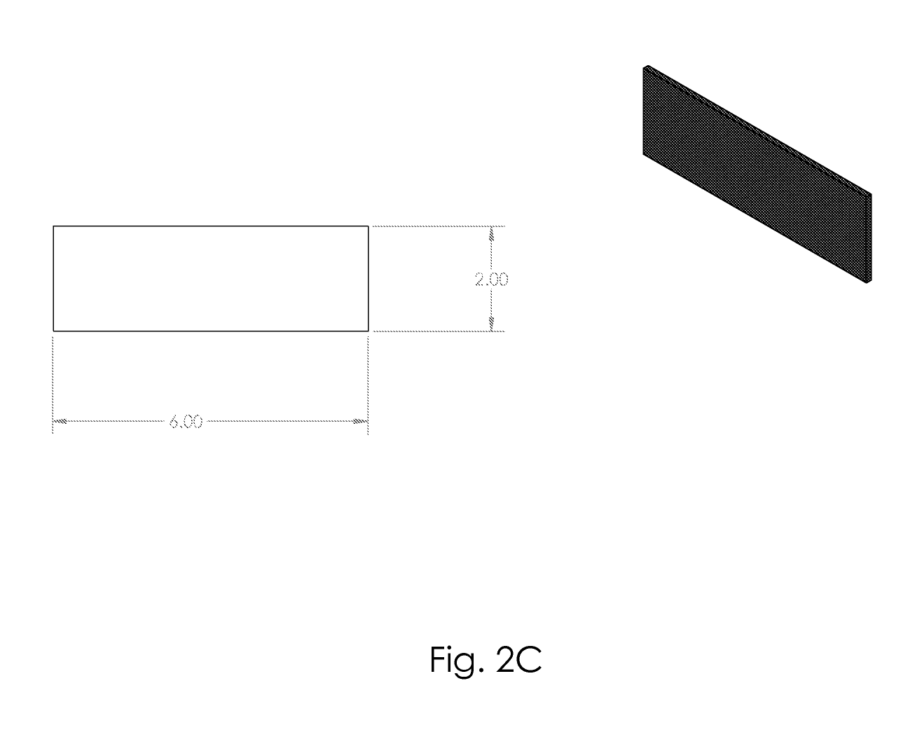

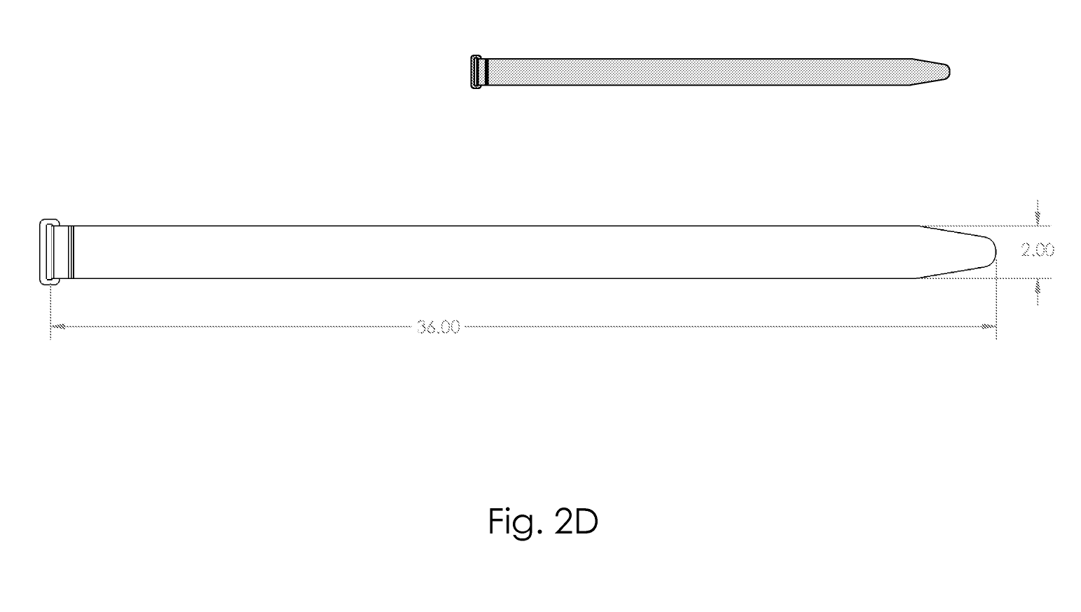

### Making Trash Bin Caddie (FIG. 2):

### Material Requirements:

2″×68″ Nylon Webbing, ½″×8″ Wood Dowel, 2″×36″ Velcro Straps×2, and sewing thread.

### Equipment Requirements:

Sewing Machine, measuring device (ruler, tape measure, etc. . . . ), heating device (flame, torch, etc. . . . ) & cutting device (scissors, knife, wood saw, etc. . . . ).

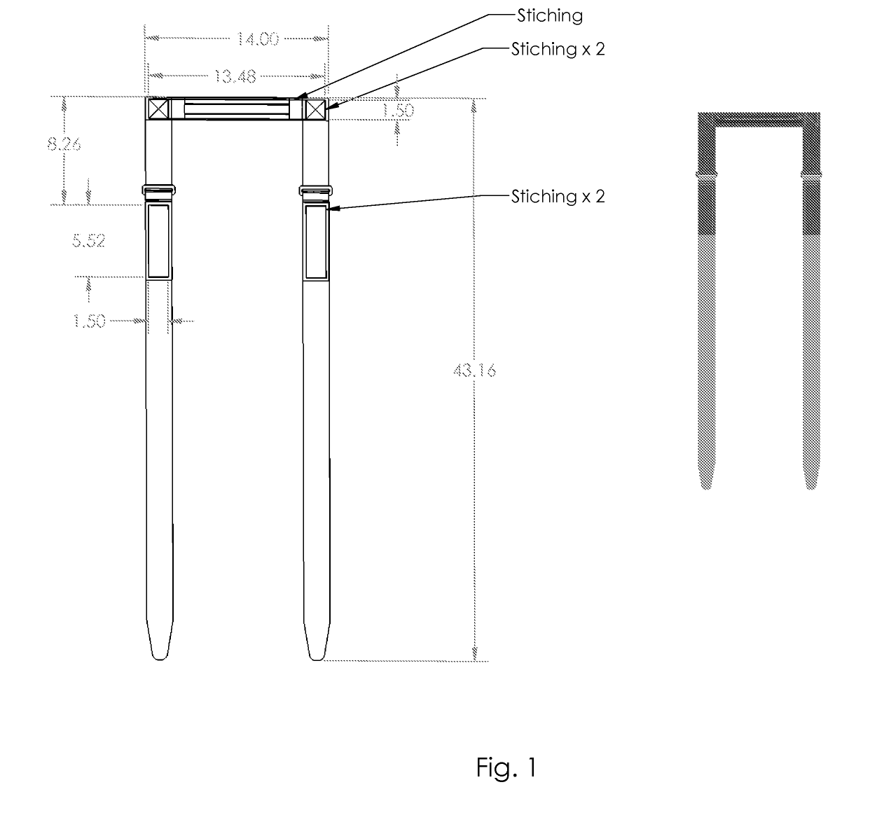

First, measure and cut nylon webbing into 14″ lengths (FIG. 2A). You will need four (4) pieces that are 14″ in length. With the remaining 12″ of nylon webbing, measure and cut into 6″ lengths (FIG. 2C). You will end up with two (2) pieces that are 6″ in length. Using any heating source, singe the cut ends of the nylon webbing to prevent the loose threads from unraveling. Next, using two (2) of the 14″ nylon webbing pieces, place them on top of each other making sure you align the edges together so they appear to be a single piece. While keeping the first two (2) pieces together, use one (1) of the remaining two (2) 14″ nylon webbing pieces and slide one corner of the nylon webbing in-between the first two (2) pieces at one of the corners so the nylon webbing pieces are perpendicular to one another. Make sure you keep the edges aligned of all three (3) pieces aligned at the corner. At this point, you should have used three (3) pieces of the 14″ nylon webbings and they should form an 1′ shape laying flat. Using a sewing machine (threaded with sewing thread), start sewing the corner of the three (3) pieces beginning at the top outside edge. Sew across the top edge going in the direction of the opposite corner, sewing approximately 1.5″ in length. After sewing approximately 1.5″ in length, stop the sewing machine and rotate the nylon webbings 90 degrees and sew approximately 1.5″ in length in the direction of the bottom edge of the nylon webbings. Again, stop the sewing machine and rotate 90 degrees. Sew another length approximately 1.5″ going back in the direction of the outside edge along the bottom. After approximately 1.5″, stop the machine and rotate 90 degrees. Sew the final line going in the direction of where you began sewing. Sew approximately 1.5″ in length which will result in a sewing pattern of a ‘box’ design. Four equal sides of approximately 1.5″ in length. Complete the sewing of the corner by sewing two (2) diagonal lines inside the ‘box’, essentially making an ‘X’ pattern inside the ‘box’. When you have completed the corner, it should resemble a box with an ‘X’ inside of it. Next, beginning sewing from the top corner and sew along the top edge of the two (2) pieces of nylon webbings making sure you stop sewing approximately 2″ from the edge of the opposite corner. You need to leave approximately 2″ of the corner not sewn together to allow for the insertion of the final nylon webbing piece. Stop the sewing machine and repeat the same process for the bottom edge. Start at the bottom corner and sew along the bottom edge of the two (2) pieces of nylon webbings making sure you stop sewing approximately 2″ from the edge of the opposite corner. Again leaving room to insert the final nylon webbing piece. At this point, you should have one (1) corner of Trash Bin Caddie completely sewn together and both the top and bottom edges sewn together of the two (2) pieces, but not the entire length of Trash Bin Caddie. The result should be a ‘pocket’ in-between the first two (2) nylon webbing pieces that were placed on top of each other. Cut the ½″ wood dowel to a length of 8″ (FIG. 2B), the most common size available commercially is ½″×36″ wood dowel, so you will have material remaining to make more Trash Bin Caddies. Insert the ½″×8″ wood dowel into the open end of the ‘pocket’ you created in-between the first two (2) nylon webbing pieces. Be sure to push the wood dowel into the ‘pocket’ as far as you can. You may need to use the remaining piece of wood dowel to assist with this process. Once the wood dowel is in place, you can close the pocket by sewing the final corner together. Follow the same instructions as you did for the first corner. Using the final 14″ nylon webbing piece, slide it in-between the first two (2) pieces of nylon webbing making sure the align the edges and making sure the final piece is perpendicular with the first two (2) pieces. Again the corner should look like an 1′ shape when laying flat. Begin sewing again from the outside edge of the top corner going in the direction of the opposite corner. Sew approximately 1.5″, stop, rotate 90 degrees; and continue the process of sewing and rotating until you have completed the ‘box’ pattern with the two (2) diagonal lines to complete the ‘X’ just as before. So again you complete the corner with a sewing pattern that resembles a box with an ‘X’ inside of it. At this point, Trash Bin Caddie should resemble something similar to this: [symbol] a primary top piece with two (2) extensions that are perpendicular to the primary top piece. The final step is to sew the velcro straps to Trash Bin Caddie. The velcro straps are pre-assembled with a buckle on one end and the tapered fastener on the other (FIG. 2D). Measuring from the end of one (1) of the extensions going in the direction towards the primary top piece, place one (1) velcro strap buckle end at 6″ from the bottom edge of the extension. Be sure to place the velcro strap on top of the nylon webbing extension piece and be sure to place the ‘fuzzy’ side down, which will result in the smooth side facing up. The tapered fastener end should point away from the primary top piece and will be longer than the nylon webbing extension piece. Next, using one (1) of the 6″ nylon webbing pieces, place the 6″ nylon webbing on top of the velcro strap, aligning an edge of it with the bottom of the buckle so that the velcro strap is layered in-between the nylon webbing extension and the 6″ nylon webbing piece. Begin sewing the 6″ nylon webbing with the velcro strap to the nylon webbing extension just below the buckle end of the velcro strap located 6″ from the bottom edge of the nylon webbing extension. Start at the top corner and sew approximately 1.5″ across following the edge of where the buckle is incorporated into the strap. Stop the machine and rotate 90 degrees. Sew along the edge of the webbing and strap in the direction of the tapered end approximately 4″-5″. Stop and rotate again to sew along the bottom edge approximately 1.5″ and finally rotate again to sew approximately 4″-5″ returning to your starting point. As before. you should have made a sewing pattern in the shape of a ‘box’, but more like a rectangle this time. If you like, you can choose to sew the two (2) diagonal lines in the box to make an ‘X’. Repeat this process with the remaining nylon webbing extension, the final 6″ nylon webbing piece, and the remaining velcro strap. Remembering to place the buckle end of the velcro strap 6″ from the bottom edge of the nylon webbing extension piece, ‘fuzzy’ side down, smooth side up; with buckle pointing toward the primary top piece and tapered end point away from primary top piece. Place the final 6″ nylon webbing piece on top of the strap and sew the ‘box’ pattern to secure the 6″ nylon webbing with the velcro strap to the nylon webbing extension. The process is complete and Trash Bin Caddie is ready for use (FIG. 1).

### Using Trash Bin Caddie:

### Cars (Trunk or Hatchback):

Open the trunk or hatchback of the automobile. Place the primary top piece of Trash Bin Caddie on the inside edge of the truck or hatchback opening. Place Trash Bin Caddie away from the latch mechanism to the left or right side of the trunk or hatchback opening. Be sure to leave enough room between Trash Bin Caddie if you are using more than one (1); for example if you are connecting your rolling trash bin and rolling recyclable bin to your vehicle, you should place one (1) on the right (passenger side) and one (1) on the left (driver side). Once you have positioned Trash Bin Caddie on the inside edge of your trunk or hatchback, close your trunk or hatchback. The extension pieces, which include the velcro straps, will be exposed and extended from underneath your trunk or hatchback. Firmly pull on the extension straps to secure the primary top piece into place against the inside of your trunk or hatchback. The wood dowel provides the right amount of bulk to prevent Trash Bin Caddie from sliding through the slight opening in your trunk or hatchback. The nylon webbing extensions are thin and will not damage the edge of your trunk or hatchback (consider the effect when you close your nylon webbing in your door when exiting the vehicle). The nylon webbing extensions are very strong and will hold your rolling trash bin or rolling recyclable container. Roll your trash bin or recyclable container to the rear of your vehicle. With the ‘handle’ portion of your trash bin or recyclable container facing the rear of your vehicle, tilt the trash bin or recyclable container towards the extension straps of Trash Bin Caddie. While holding the container with one hand, use your other hand to wrap the velcro strap around the handle of the container (recommend starting underneath the handle and pulling the strap up towards the buckle fastener). Fasten the velcro strap by looping the tapered end through the buckle and pulling it back towards the handle of the container. The tapered end has the ‘sticky’ side that adheres to the ‘fuzzy’ side. Attach the tapered end to any location along the exposed fuzzy side of the velcro strap. This allows for you to adjust the length to meet you needs. Follow the same process to secure the second velcro strap to the handle of the container. You can connect another container to your vehicle in the same fashion. Your trash bin or recyclable container will cradle (hang) in the harness ready to be towed (pulled) behind your vehicle. The extension straps protect your vehicle from the container if it happens to rock or sway in the harness. Drive your vehicle at safe speeds while towing your trash bin or recyclable containers, typically 15 mph or less. Trash Bin Caddie is not designed for highway use. When you have completed the transport of your containers, just unfasten the velcro straps to remove your containers and open your trunk or hatchback to remove Trash Bin Caddie.

### SUVs (Lift Gate):

Follow the instructions for a car due to the similarity of the hatchback with the lift gate on SUVs.

### Trucks (Bed/Tail Gate):

Open the bed/tail gate for the truck and allow it to rest in the normal parallel to the ground position. Start with the two extensions of Trash Bin Caddie and slide them through the slight opening between the bed of the truck and the bed/tail gate. You may have to slightly lift up on your bed/tail gate depending on the year, make or model of your truck. Once the primary top piece of Trash Bin Caddie has reached the opening between the bed of the truck and the bed/tail gate, close the bed/tail gate. Firmly pull on the extension straps to secure the primary top piece into place. Be sure not to close the bed/tail gate on the wood dowel of Trash Bin Caddie as this could damage Trash Bin Caddie. Once Trash Bin Caddie is secured, follow the instructions for securing the velcro straps found in the instructions for car use.

1. A harness apparatus used to attach a variety of storage containers to the trunk, lift gate or tail gate of vehicles such as sedans, hatch backs, sport utility vehicles and pick up trucks.
a. a flexible u-shaped harness made with nylon webbing having a single base with two parallel extensions opposite each other located at the end of the single base;
b. the two extensions being sewn into the single base using heavy duty thread each extension being perpendicular to the single base;
c. an elevated rigid ridge across the single base created by the insertion of a wood dowel which is sewn into the single base;
d. elevated rigid ridge creates bulk which prevents harness apparatus from slipping thru trunk closure, hatch back closure, lift gate closure or tail gate closure;
e. harness apparatus assembled by sewing process resulting in single base and two extensions having completely encased operations without exposure of support features;
f. two parallel extensions having hook and loop velcro elements at the ends with sewn in buckle used to secure storage containers to vehicle;
g. no hinged elements, no glue, no snaps or fasteners used in the design or manufacturing of harness apparatus;
h. harness apparatus does not require vehicle to have a towing hitch or a luggage rack when securing storage containers to vehicle;
i. harness apparatus must first be mounted to vehicle prior to securing storage containers.

2. The harness apparatus of claim 1 further comprising:
a. the storage containers which can be secured to a vehicle are soft sided storage containers such as back packs, duffle bags, equipment totes, sporting goods totes or coolers;
b. the storage containers allow for exterior storage of items not desirable to be placed inside a vehicle such as items containing mud, dirt, sand, paint or any liquid or material which could damage or stain the interior of a vehicle;
c. the storage containers also being a rolling trash bin or rolling recyclable bin that have wheels or rollers;
d. the storage containers are secured to a vehicle after the harness apparatus has been first mounted to a vehicle by placing the elevated rigid ridge just beyond the point of contact related to the trunk closure, hatch back closure, lift gate closure or tail gate closure;
e. the storage containers are then secured to a vehicle by wrapping the ends of the two extensions from the harness apparatus around any handles, buckles or straps of the storage containers and then feeding the ends thru the buckles sewn on the harness apparatus, and finally securing the ends to the hook and loop element of the velcro;
f. the width of harness apparatus at a length of fourteen inches allows for multiple harness apparatus to be mounted to the trunk, hatch back, lift gate or tail gate of a vehicle;
g. the mounting of multiple harness apparatus allows for securing two or more storage containers such as soft sided back packs, duffle bags, equipment totes, sporting goods totes, coolers, rolling trash bins or rolling recyclable bins.
